(19) United States
(12) Patent Application Publication
(10) Pub. No.: US 2005/0204381 A1
(43) Pub. Date: Sep. 15, 2005

(54) Targeted advertising based on consumer purchasing data

(75) Inventors: Edward A. Ludvig, Redwood City, CA (US); David de Heer, Woodside, CA (US); Andrew K. Sheldon, Redwood City, CA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/798,153

(22) Filed: Mar. 10, 2004

(51) Int. Cl. H04N 7/025; H04N 7/10

(52) U.S. Cl. 725/34; 725/35

(57) ABSTRACT

Techniques for targeting advertisements based on consumer purchasing data are described. Consumer purchasing data is used to generate a profile associated with a subscriber to a broadcast television system. Consumer profile characteristics may also be associated with an advertisement that is to be targeted. Prior to broadcasting a targeted advertisement, a message is broadcast that notifies a client device of the consumer profile characteristics associated with the upcoming targeted advertisement. If the consumer profile characteristics associated with the targeted advertisement match the subscriber profile associated with the subscriber of the client device, then the client device tunes to an alternate data stream over which the targeted advertisement is broadcast. Otherwise, a default advertisement is received over the originally tuned data stream.

### TECHNICAL FIELD

This invention relates to targeted advertising, and more specifically to targeting advertisements based on consumer purchasing data.

### BACKGROUND

Targeting advertisements to consumers can be an important source of revenue for retail and service companies. Advertisements may be directed to consumers in a variety of ways, including by postal mail, radio, and television. By targeting advertisements to consumers who are more apt to purchase the product being advertised, advertising budgets may be used more effectively. Postal mail, radio, and television are vehicles for broadcasting advertisements to large numbers of consumers, but, at least in the past, have not been conducive to targeting advertisements to specific individuals.

Methods that currently exist for targeting advertisements may include presenting web-based advertisements to individuals based on web sites that the person has viewed; mailing advertisements to different people based on geographic locations; advertising products during a particular time period on a particular radio station; advertising products during particular television programs based on demographic data that describes a group of people who typically watch the television program; and so on.

While purchasing advertising spots during particular television programs is a form of targeted advertising, this technique is based on demographics, which does not necessarily correspond to viewers' purchasing behavior. That is, viewers with similar demographics may have diverse purchasing behavior. For example, while viewers between the ages of 19 and 27 may be known to watch a particular television program, consumers between the ages of 19 and 27 may have very diverse purchasing habits. For example, some of those viewers aged 19-27 may be married with children, and therefore purchase diapers and other baby products. At the same time, others of the viewers aged 19-27 may be single and childless, with no interest in purchasing diapers and other baby products. Given this scenario, advertising diapers to all viewers of the television program may not be the best use of advertising dollars.

If, however, a diaper ad could be shown to those viewers who have recently purchased diapers (or other baby products) while an advertisement for another product (e.g., toothpaste) is shown to other viewers of the same program, the broadcaster (e.g., cable television company) could charge more for the targeted ad spot because the targeted ad is being shown only to viewers with a history of purchasing the same or similar products.

Accordingly, a need exists for a technique that enables television advertisements to be targeted to television viewers based on data that describes the television viewers' previous consumer purchasing behavior.

### SUMMARY

A technique for targeting advertisements based on consumer purchasing data is described. Profiles are generated for broadcast television system subscribers based on consumer purchasing data maintained, for example, by retail and service providers. A particular advertisement is targeted by associating the advertisement with one or more consumer profile characteristics.

Upon detection of an advertisement avail that is to include a targeted advertisement, a message is broadcast indicating that a targeted advertisement will be broadcast soon. The message includes data that identifies the profile characteristics associated with the targeted advertisement, and a data stream location to which a client device can tune to receive the targeted advertisement. The targeted advertisement and a default, non-targeted advertisement, are then broadcast simultaneously on two separate data streams.

A client device is configured to receive the message indicating an upcoming targeted advertisement, compare locally stored subscriber profile data with the profile characteristics associated with the targeted advertisement, and determine whether to tune to the targeted advertisement or to allow the default advertisement to be rendered.

### BRIEF DESCRIPTION OF THE DRAWINGS

FIG. 1 is a block diagram that illustrates an exemplary network environment that supports targeted advertising.

FIG. 2 is a display screen representation of an exemplary profiling user interface.

FIG. 3 is a display screen representation of an exemplary targeting user interface.

FIG. 4 is a block diagram of an exemplary data structure according to which the subscriber profile data repository illustrated in FIG. 1 may be implemented.

FIG. 5 is a block diagram that illustrates select components of an exemplary client device as illustrated in FIG. 1.

FIG. 6 is a block diagram that illustrates an exemplary targeted advertising data transmission scenario.

FIG. 7 is a flow diagram that illustrates an exemplary method for targeting advertisements based on television viewer consumer purchasing data.

FIG. 8 is a flow diagram that illustrates an exemplary method for receiving targeted advertisements.

### DETAILED DESCRIPTION

Overview

The embodiments described below provide techniques for targeting television advertisements based on consumer purchasing data. Consumer purchasing data is used to generate profiles associated with broadcast television system subscribers. The profiles are based on data that describes individual subscribers' consumer purchasing behavior (e.g., as maintained by a grocery store in association with a store membership card).

Targeted television advertisements are associated with one or more consumer profile characteristics. Multiple advertisements are then broadcast simultaneously, and a profile filter is used to determine which of the multiple advertisements is to be rendered, based on a comparison between profile data associated with the television viewer and profile characteristics associated with the advertisements.

Network Environment

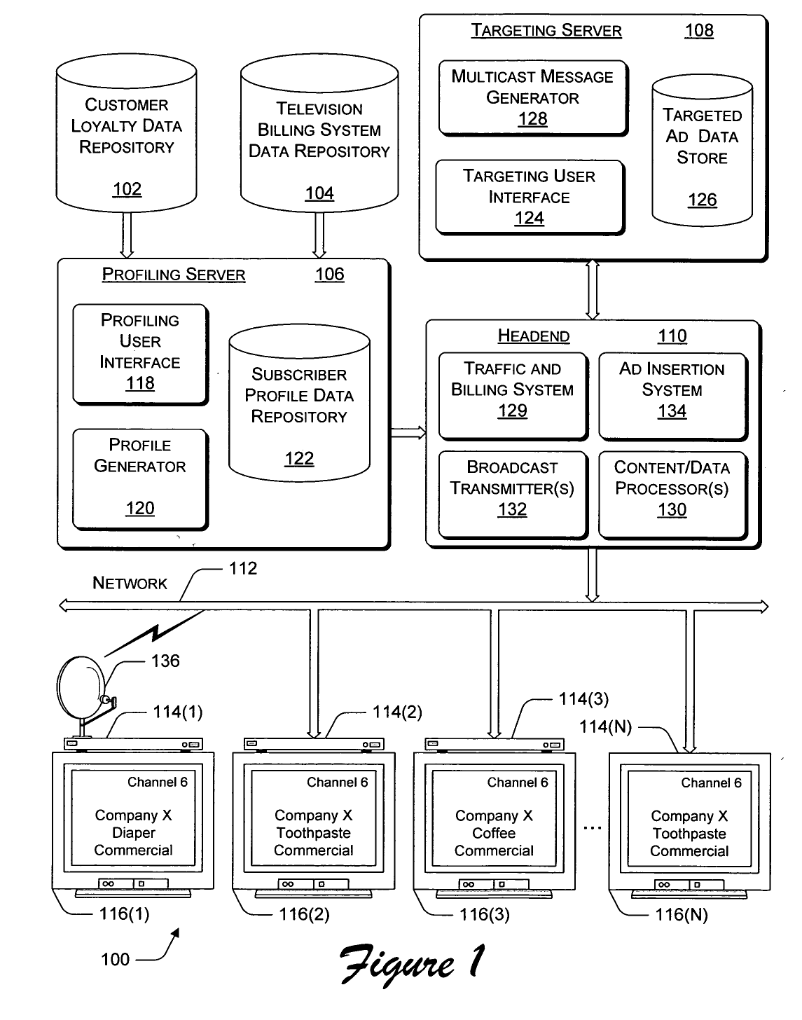

FIG. 1 illustrates an exemplary network environment 100 in which targeted advertising based on consumer purchasing data may be implemented. Environment 100 includes customer loyalty data repository 102, television billing system data repository 104, profiling server 106, targeting server 108, headend 110, network 112, and multiple client devices 114(1), 114(2), 114(3), . . . , 114(N), each with an associated display device 116(1), 116(2), 116(3), . . . , 116(N). In the illustrated implementation, headend 110 is representative of a cable television system headend, and client devices 114 are representative of television set-top boxes or any other type of client device configured to receive digitally encoded broadcast media content (e.g., television programs) and other data (e.g., electronic program guide data, video-on-demand content, subscriber profile data, targeted advertising data, etc.) over network 112. A client device 114 may also be implemented as a digital video recorder (DVR) configured to digitally record media content such as broadcast television programs, which can then be played back for a viewer's enjoyment at a later time.

As illustrated on the screens of display devices 116(1), 116(2), 116(3), . . . , and 116(N), targeted advertising enables different advertisements to be rendered through different client devices, even though the client devices are all tuned to the same broadcast channel. For example, as illustrated in FIG. 1, client devices 114(1), 114(2), 114(3), and 114(N) are all simultaneously tuned to channel 6, indicating that they were all initially tuned to the same broadcast program. However, while client devices 114(2) and 114(N) are receiving a toothpaste commercial, client device 114(1) is receiving a diaper commercial and client device 114(3) is receiving a coffee commercial.

This may be desirable for a company like Proctor and Gamble that sells, among other things, toothpaste, coffee, and diapers. A company representative responsible for advertising may identify a toothpaste advertisement as a default advertisement and a coffee advertisement and a diaper advertisement as targeted advertisements. In this way, the coffee and diaper ads can be targeted, but to viewers for whom coffee and/or diapers are not of interest (based on consumer purchasing data that has been gathered), the default toothpaste ad may be shown.

Customer loyalty data repository 102 is representative of one or more data repositories that maintain consumer purchasing data. For example, a grocery store chain may gather and maintain data that describes purchases made by shoppers who carry a membership card issued by the grocery store chain. Such membership cards are often promoted as providing shoppers with extra savings, but may also be used to record purchases made by the shoppers, thereby giving the store owner valuable information regarding which consumers purchase which products; how often specific products are purchased; and so on. For example, when a consumer purchases products at a grocery store, when checking out, a barcode on the consumer's membership card may be scanned, and a record of items purchased may thereby be recorded in customer loyalty data repository 102.

Customer loyalty data repositories may be maintained by any sort of retail store, service provider, or other entity that interacts with consumers and has a desire to advertise to those consumers. Furthermore, customer loyalty data repositories may be structured in any number of ways, including as a relational database, an object-oriented database, an XML file, one or more formatted text files, and so on.

Television billing system data repository 104 is maintained by a broadcast television service provider, such as a cable television company. Television billing system data repository 104 may be structured in any number of ways, and typically includes data for each subscriber that identifies the subscriber's name, telephone number, billing address, and client device identifier. The client device identifier may be, for example, a unique identifier associated with a cable television set-top box through which the subscriber receives broadcast television programs and other data.

Profiling server 106 is configured to access data in television billing system data repository 104 and customer loyalty data repository 102, and use that data to generate profiles for television viewers who are identified in the television billing system data repository 104. The generated profiles describe consumer purchases (as tracked in customer loyalty data repository 122) made by television system subscribers (as identified in television billing system data repository 104). Profiling server 106 includes a profiling user interface 118, profile generator 120, and subscriber profile data repository 122.

Because multiple customer loyalty data repositories may be supported (each associated with a different retail store or service provider), and each may be structured differently, profiling user interface 118 is configured to enable a user (e.g., a system administrator) to customize profiling server 106 to communicate with a particular customer loyalty data repository 102. For example; if customer loyalty data repository 102 is configured as a relational database, the system administrator may use profiling user interface 118 to define structured query language (SQL) queries that identify from which fields data is to be pulled for generating subscriber profiles.

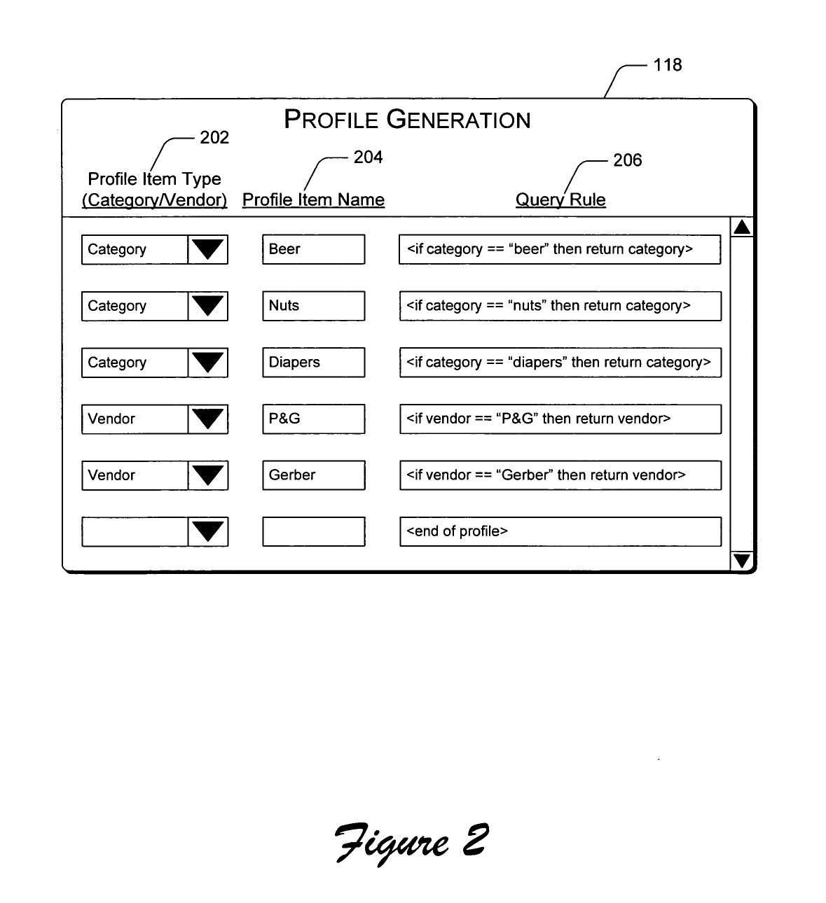

Profiling user interface 118 is further configured to enable a user (e.g., a system administrator) to indicate specific values that may be used in defining a subscriber profile. In an exemplary implementation, product categories and product vendors may be used to define a subscriber profile. An exemplary profiling user interface 118 is illustrated in FIG. 2, and described in further detail with reference thereto below.

Profile generator 120 is configured to extract subscriber data from television billing system data repository 104, and use one or more elements of the subscriber data (e.g., the subscriber telephone number) to extract consumer purchasing data associated with the subscriber from customer loyalty data repository 102. Profile generator 120 then formats the extracted data and stores it in subscriber profile data repository 122.

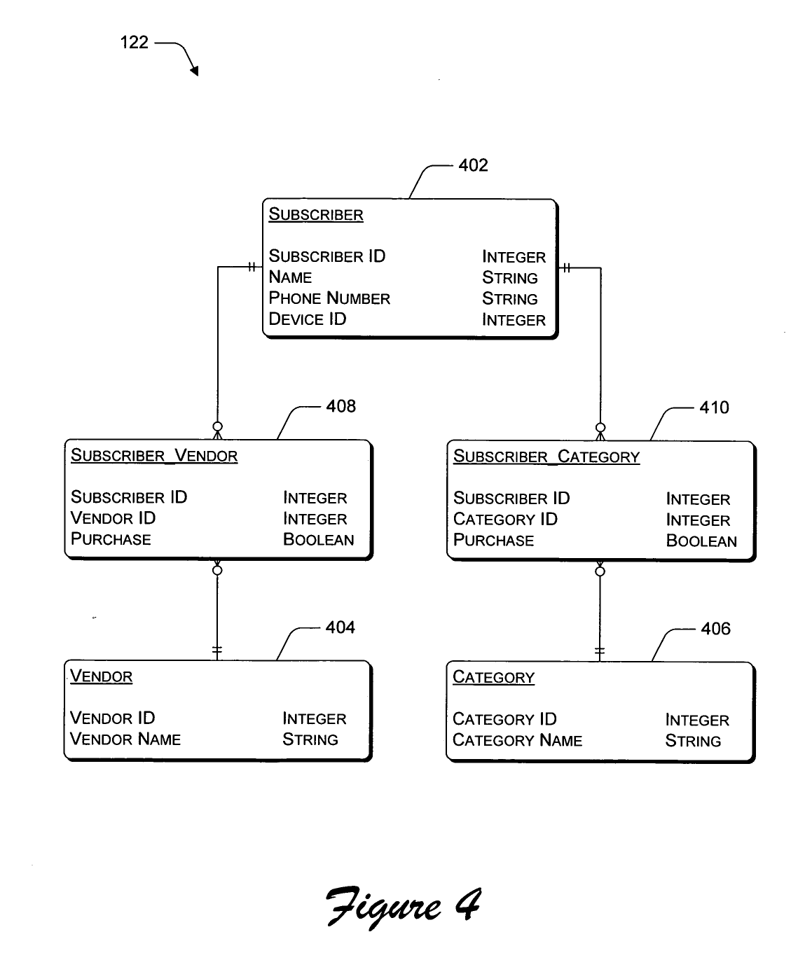

Subscriber profile data repository 122 maintains subscriber profiles that are generated by profile generator 120. In an exemplary implementation, a subscriber profile is based on both product categories and product vendors. Example product categories include, alcoholic beverages, baby supplies, feminine care products, frozen foods, organic products, and so on. Example product vendors include Proctor & Gamble, Anheuser-Busch, Johnson & Johnson, Gerber, and so on. In the described exemplary implementation, each subscriber profile includes a listing of the top n product categories and the top m product vendors associated with products the subscriber may have purchased. The values of n and m may be configurable, and in an exemplary implementation are numbers between 100 and 500. FIG. 4, described below, illustrates an example data structure according to which subscriber profile data repository 122 may be implemented.

Targeting server 108 is configured to manage targeted advertising data that supports targeting advertisements to television viewers based on the subscriber profiles that are generated by profiling server 106. Targeting server 108 includes a targeting user interface 124, targeted ad data store 126, and multicast message generator 128.

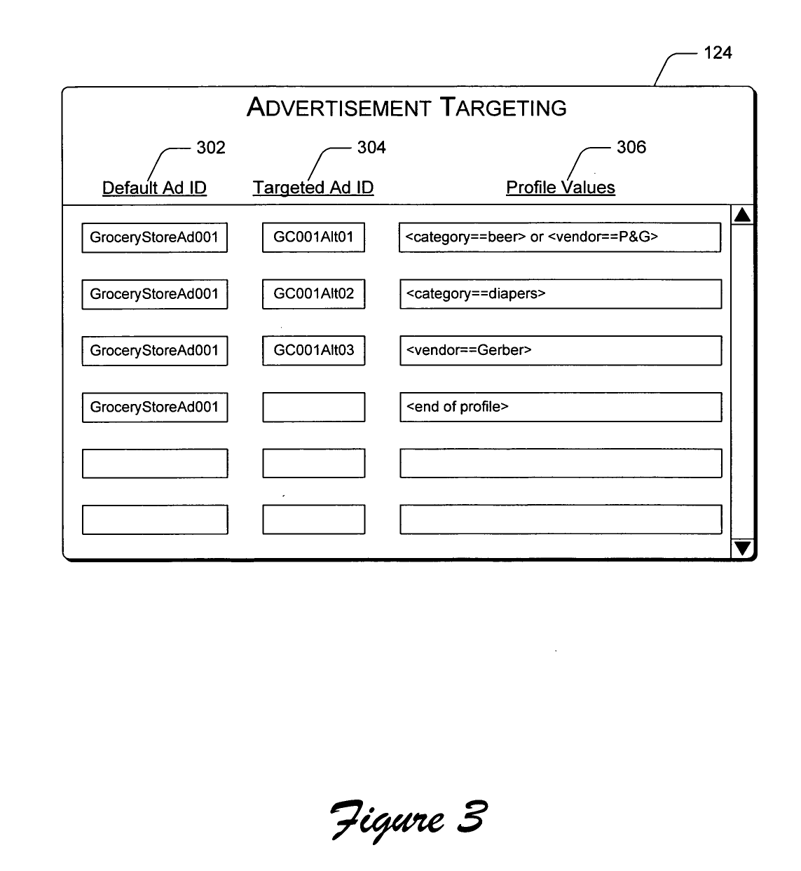

Targeting user interface 124 is configured to enable an individual (e.g., a system administrator) to specify which advertisements are to be targeted and what profile characteristics are to be used to target the ads. An exemplary targeting user interface 124 is illustrated in FIG. 3, and described in further detail with reference thereto below.

Targeted ad data store 126 is configured to maintain the data that is entered using targeting user interface 124. Targeted ad data store 126 also maintains data that associates default advertisements with upcoming local ad avails. For example, targeted ad data store 126 may receive ad ID/ local ad avail ID mappings from traffic and billing system 129 (described below with reference to headend 110). Targeted ad data store 126 may also be configured to store the actual advertisement content associated with the default and/or targeted advertisements. Accordingly, although not shown in FIG. 1, targeting server 108 may also include an interface through which advertisement content may be received.

Multicast message generator 128 listens to the transport stream of the broadcast channels of interest. When multicast message generator 128 detects a cue signal (either analog or digital) associated with a local ad avail, it checks data in targeted data store 126 based on the avail ID to identify a default ad to be broadcast in associated with the upcoming local ad avail. The data stored in targeted ad data store also identifies whether or not there are targeted ads to be broadcast simultaneously along with the default advertisement. If targeted ads are to be included, multicast message generator 128 transmits the transport IDs, associated profile characteristics, and a duration of the targeted advertisements to be broadcast. Multicast message generator 128 may be implemented to transmit data identifying upcoming targeted advertisements in various ways, depending on the specific implementation. For example, in an analog system, multicast message generator 128 may multicast the data. Alternatively, the data may be broadcast in a synchronized data stream associated with a service on which the television program is being broadcast. A client device receiving the data is thereby made aware that a targeted ad avail is coming up. The client device can then examine the data that is received and compare locally stored profile data to determine whether to render a targeted advertisement or a default advertisement.

Headend 110 includes traffic and billing system 129, content/data processor(s) 130, broadcast transmitter(s) 132, and ad insertion system 134. Headend 110 typically includes other components as well, which are not illustrated in FIG. 1, such as a processor, one or more memory components, one or more network interfaces, and so on.

Traffic and billing system 129 is configured to associate advertisements with local ad avails. Traffic and billing system 129 identifies local ad avails in scheduled broadcast programs, and schedules one or more local advertisements to be aired during the identified avails. Scheduling of advertisements may be based, for example, on negotiated guidelines that specify how often a particular advertisement is to be broadcast. In an exemplary implementation, traffic and billing system 129 assigns each local ad avail a unique identifier. Traffic and billing system 129 then transmits mappings between the assigned ad avail identifiers and identifiers associated with the advertisements to be broadcast during the local avail to targeting server 108.

Content/data processor(s) 130 are configured to process and format data and content that is to be broadcast over network 112. For example, electronic program guide data may be filtered and/or formatted before being broadcast and broadcast program content (including advertisement content) may be formatted and remodulated onto network 112.

Broadcast transmitter 132 is configured to transmit data over network 112 to one or more of the client devices 114. Data that may be broadcast may include, but is not limited to, broadcast program content, electronic program guide data, subscriber profile data, and targeted advertising data. Network 112 may include one or more in-band network channels and one or more out-of-band network channels. In the described implementation, broadcast program data is typically broadcast over in-band channels while EPG data and subscriber profile data are typically broadcast over out-of-band channels.

Ad insertion system 134 is an extant, legacy system configured to splice advertisements onto digital transport streams for local ad avails. It is triggered by a cue signal (e.g., a dual-tone multi-frequency (DTMF) signal or a digital signal, which is embedded typically six seconds before a local ad avail) and delivers a pre-determined ad onto a pre-determined transport at the right time. The process of inserting advertisements based on cue signals is well known to those skilled in the art. In the described implementation, ad insertion system 134 is configured to insert a default advertisement into a data stream that contains a local ad avail cue signal. In this way, client devices that do not support targeted advertising and client devices that determine that a particular targeted advertisement does not apply (based on locally stored subscriber profile data) will receive the default advertisement without having to perform any additional processing.

Although illustrated as separate entities, profiling server 106 and/or targeting server 108 may alternatively be implemented as components of headend 110.

Client devices 114(1), 114(2), 114(3), . . . , 114(N) are configured to receive broadcast television programs, subscriber profile data, targeted advertising data, and other data (e.g., electronic program guide data) over broadcast network 112. Client devices 114 may be implemented as any of a number of devices. For example, client device 114(1) is representative of a satellite television set-top box configured to receive broadcast television data through satellite receiver 136. Additional non-television type client devices may also be implemented to receive targeted advertisements. Such client devices may include, but are not limited to, a computer kiosk, a cellular telephone, and a personal digital assistant (PDA).

Client device 114(2) is representative of a television set-top box configured to receive digitally encoded broadcast media content.

Client device 114(3) is representative of a television set-top box with integrated DVR. Accordingly, client device 114(3) may be configured to receive broadcast programs and to enable digital recording of one or more of the broadcast programs.

Client device 114(N) is representative of an integrated component of display device 116(N). For example, display device 116(N) may be implemented as a television with an integrated digital receiver.

FIG. 1 illustrates four example client device configurations, but it is recognized that any number of client device configurations may be implemented to support targeted advertising as described herein. Furthermore, network 112 may be implemented as any type of network that supports the client devices 114.

Exemplary Profiling User Interface

FIG. 2 illustrates an exemplary profiling user interface 118. In the illustrated example, a system administrator defines possible profile characteristics by selecting a profile item type 202, entering a profile item name 204, and entering a query rule 206. In the illustrated example, a profile item type 202 is selected from a drop-down list containing “category” and “vendor”. The profile item name 204 is a descriptive name to be associated with the profile item. Example profile item names for categories may include, but are not limited to, beer, diet foods, baby products, diapers, organic products, and so on. Example profile item names for vendors may include any company name under which products are sold. Query rule 206 defines a query to be executed against customer loyalty data repository 102 to define a particular user's profile.

Exemplary Targeting User Interface

FIG. 3 illustrates an exemplary targeting user interface 124. In the illustrated example, a system administrator associates a default advertisement 302 with one or more targeted advertisements 304. For each targeted advertisement 304 specified, one or more profile values 306 are also specified that indicate what profile characteristics are to be used to target the ad to particular viewers.

Subscriber Profile Data Repository

As described above, subscriber profiles based on consumer purchasing data are generated to support targeted television advertisements. FIG. 4 illustrates an exemplary relational data structure according to which subscriber profile data repository 122 may be implemented. In the illustrated example, subscriber data (which may be extracted from television billing system data repository 104) is stored in a subscriber table 402. Subscriber data may include, for example, a unique subscriber ID, a subscriber name, a telephone number, and a unique identifier associated with the subscriber's client device (e.g., television set-top box). Alternate implementations may include different combinations and/or additional subscriber data, including, for example, a subscriber mailing address.

Product vendor data (which may be entered through profiling user interface 118, extracted from customer loyalty data repository 102, or received by some other means) is stored in vendor table 404. Vendor data may include, for example, a unique vendor ID and a vendor name (e.g., Proctor & Gamble, Johnson

Product category data (which may be entered through profiling user interface 118, extracted from customer loyalty data repository 102, or received by some other means) is stored in category table 406. Category data may include, for example, a unique category ID and a category name (e.g., frozen foods, alcoholic beverages, baby supplies, feminine care products, etc.).

Subscriber_vendor table 408 and subscriber_category table 410 are used to store data that identifies each subscriber's relationship with each product vendor and each product category, respectively, based on data extracted from customer loyalty data repository 102. For example, each record in subscriber_vendor table 408 includes a unique identifier associated with a particular subscriber, a unique identifier associated with a particular product vendor, and an indicator as to whether or not the subscriber has purchased a product that is associated with the specified product vendor. Similarly, each record in subscriber category table 410 includes a unique identifier associated with a particular subscriber, a unique identifier associated with a particular product category, and an indicator as to whether or not the subscriber has purchased a product that is associated with the specified product category.

In an example implementation, any purchase made by a particular subscriber that is associated with a particular product category or product vendor, results in a value of “true” in the purchase field of the subscriber_vendor table or subscriber_category table, respectively. In an alternate implementation, only vendors or categories for which several purchases have been made result in a value of “true”. Alternatively, only vendors or categories for which purchase have been recently made (e.g., within the previous month) result in a value of “true”. It is recognized that any number of rules may be specified for setting the value of the purchase fields to generate meaningful subscriber profiles.

Although shown as a relational data model, it is recognized that any number of data structures may be used for subscriber profile data repository 122. Furthermore, when data is extracted from subscriber profile data repository 122 to be broadcast to client devices 114, the extracted data may be formatted in any number of ways, for example, as a binary encoded sequence of vendor and category IDs.

Exemplary Client Device

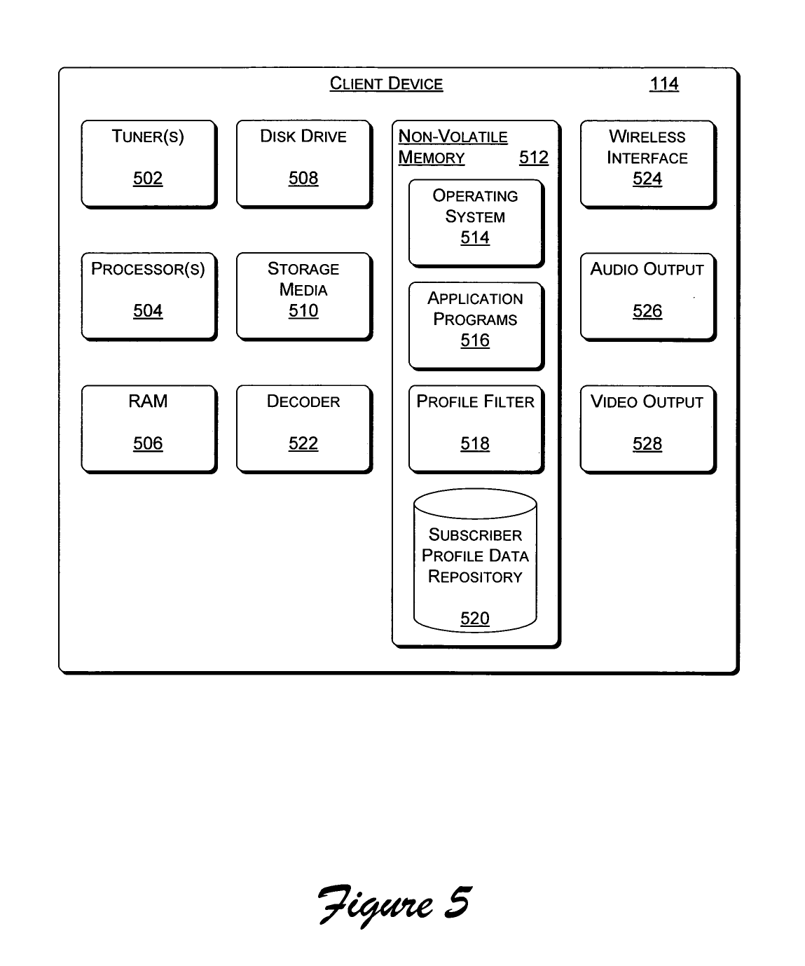

FIG. 5 illustrates select components of an exemplary client device 114. As described above, client device 114 can be implemented in any number of embodiments, for example, as a cable television set-top box, a satellite television receiver, a TV recorder with a hard disk, a personal computer, a digital-cable-ready television, a media center device that integrates broadband data and local networks with broadcast and VOD content for display on one or more display devices, and so forth. Exemplary client device 114 includes one or more tuners 502. Tuners 502 are representative of one or more in-band tuners that tune to various frequencies or channels to receive television signals, as well as an out-of-band tuner that tunes to a broadcast channel over which other data, such as subscriber profiles, electronic program guide (EPG) data, and listings of available VOD titles, may be broadcast to client device 114.

Client device 114 also includes one or more processors 504 and one or more memory components. Examples of possible memory components include a random access memory (RAM) 506, a disk drive 508, a mass storage component 510, and a non-volatile memory 512 (e.g., ROM, Flash, EPROM, EEPROM, etc.). Alternative implementations of client device 114 can include a range of processing and memory capabilities, and may include more or fewer types of memory components than those illustrated in FIG. 5.

Processor(s) 504 process various instructions to control the operation of client device 114 and to communicate with other electronic and computing devices. The memory components (e.g., RAM 506, disk drive 508, storage media 510, and non-volatile memory 512) store various information and/or data such as content, EPG data, configuration information for client device 114, subscriber profile data, graphical user interface information, and/or viewing history data.

An operating system 514 and one or more application programs 516 may be stored in non-volatile memory 512 and executed on processor 504 to provide a runtime environment. A runtime environment facilitates extensibility of client device 114 by allowing various interfaces to be defined that, in turn, allow application programs 516 to interact with client device 114. Application programs 516 that may be implemented at client device 114 may include, for example, an electronic program guide application for providing viewer access to EPG data and a video-on-demand application for enabling viewer purchase of VOD content. Profile filter 518 is a specific application that may be stored in non-volatile memory 512 and executed on processor 504. Subscriber profile data repository 520 may also be stored in non-volatile memory 512 to maintain local subscriber profile data and support profile filter 518.

In alternate implementations, rather than being stored on client device 114, one or more application programs 516 may be spooled from headend 110 and executed at the appropriate time by processor 504.

In an exemplary implementation, profile filter 518 is configured to monitor the out-of-band channel of network 112 and detect subscriber profile data to be downloaded (as identified by a client device ID). In an alternate implementation, subscriber profile data may be unicast to individual client devices over an out-of-band interactive network channel. In such an implementation, profile filter 518 listens to the out-of-band interactive network channel to detect and receive unicast data. In another alternate implementation based on a satellite network, because satellite broadcast networks typically support one-way communication, client device 114 may tune to a virtual out-of-band network to gather data (e.g., subscriber profile data). Client device 114 may be configured to gather such data during, for example, late night hours, while client device 114 is not being used to render television programs.

As described above, headend 110 broadcasts subscriber profile data that is stored in subscriber profile data repository 122 over an out-of-band channel of network 112. When profile filter 518 detects broadcasted subscriber profile data that is associated with the client device ID of client device 114, profile filter 518 collects the subscriber profile data and stores it in subscriber profile data repository 520. In an exemplary implementation, any subscriber profile data that has previously been stored in subscriber profile data repository 520 is deleted when a new set of subscriber profile data is received over network 112.

Profile filter 518 is further configured to monitor the out of band channel of network 112 and detect multicast messages generated by targeting server 108 for the in-band broadcast channel to which client device 114 is currently tuned. In an exemplary implementation, multicast messages are transmitted over the out-of-band channel of network 112. Alternatively, multicast messages may be transmitted over an in-band channel of network 112. A multicast message includes data that indicates one or more targeted ads that will soon be broadcast, profile characteristics associated with those targeted ads, transport IDs that identify broadcast channels over which the targeted ads will be broadcast, and a duration associated with the targeted advertisements. When the profile filter detects a multicast message from targeting server 108, it compares the profile characteristics specified in the multicast message to the local subscriber profile data (stored in subscriber profile data repository 520). If the profile characteristics associated with a particular targeted advertisement match the local profile data, then six seconds after the cue signal was detected (or at some other pre-defined interval), profile filter 518 sends a message to tuner 502 directing tuner 502 to tune to the data stream over which the targeted advertisement is scheduled to be broadcast, as identified by the transport ID specified in the multicast message. After the targeted advertisement has been received (e.g., after the duration specified in the multicast message), profile filter 518 instructs tuner 502 to tune back to the previous data stream to continue receiving the broadcast program data. For example, profile filter 518 may detect a trigger signal (e.g., a splice point) that indicates that signals profile filter 518 to instruct tuner 502 to tune back to the previous data stream.

Client device 114 also includes a decoder 522 to decode a broadcast video signal, such as DVB, MPEG-2, or other digitally encoded video signal. Client device 114 further includes a wireless interface 524 that allows client device 114 to receive input commands and other information from a user-operated input device, such as from a remote control device or from another IR, Bluetooth, or similar RF input device.

Client device 114 also includes an audio output 526 and a video output 528 that provide signals to a television or other display device that processes and/or presents or otherwise renders the audio and video data. Although shown separately, some of the components of client device 114 may be implemented in an application specific integrated circuit (ASIC). Additionally, a system bus (not shown) typically connects the various components within client device 114. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Client device 114 can also include other components, which are not illustrated in this example for simplicity purposes. For instance, client device 114 can include a user interface application and user interface lights, buttons, controls, etc. to facilitate viewer interaction with the device.

Data Transmission

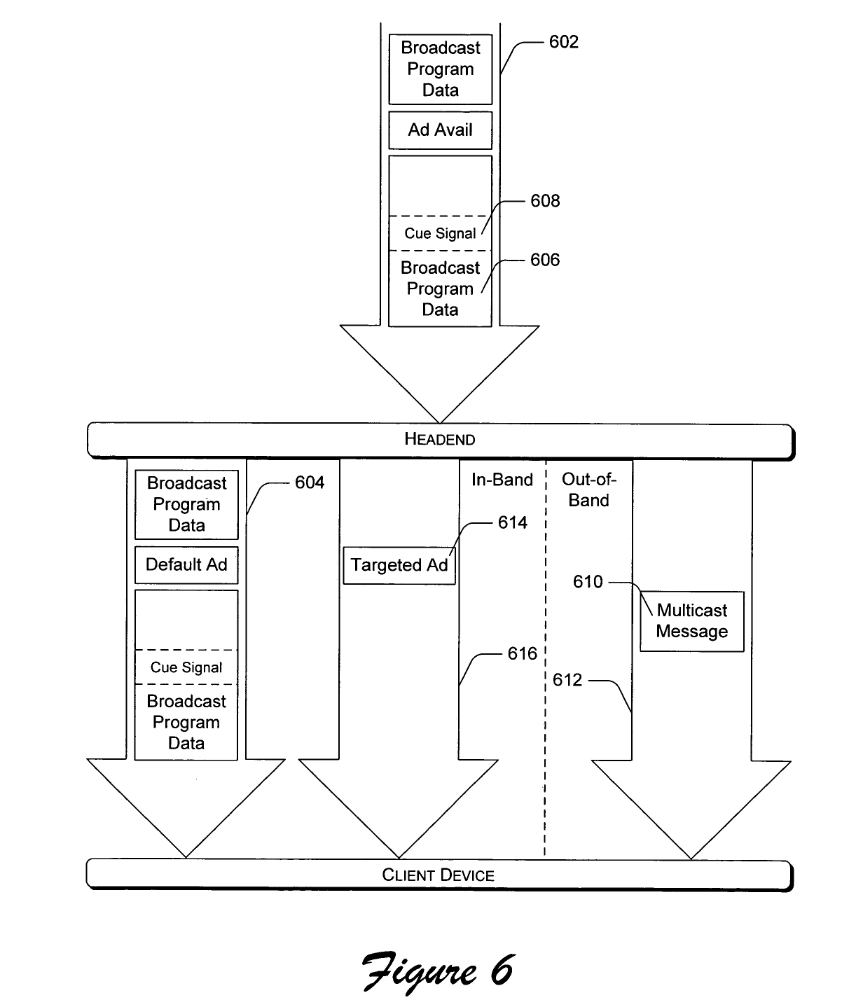

FIG. 6 illustrates an exemplary data transmission scenario that enables targeted advertising as described herein. Data stream 602 is representative of broadcast program data that is received, processed, and remodulated onto network 112 by headend 110. Data stream 604 is representative of a corresponding data stream that is broadcast over network 112 to client devices 114.

As headend 110 receives broadcast program data 606, cue signal 608 is detected. A cue signal is a well-known mechanism used to indicate an upcoming local ad avail. Cue signals are typically inserted into a data stream six seconds before a local ad avail. When headend 110 detects cue signal 608, ad insertion system 134 inserts a local advertisement (a default advertisement) into data stream 602 and headend 110 notifies targeting server 108 of the upcoming ad avail. Targeting server then examines data stored in targeted ad data store 126 to determine whether or not the upcoming ad avail is to include targeted advertisements. If targeted advertisements are to be included, then targeting server 108 generates a multicast message 610 and broadcasts it to client device 114 over an out-of-band channel 612. Targeting server 108 also broadcasts a targeted advertisement 614 on an alternate in-band data stream 616. Although FIG. 6 illustrates only one targeted advertisement, multiple in-band data streams may be used to simultaneously broadcast multiple targeted advertisements.

Multicast message 610 includes data that indicates the duration of the targeted advertisement 614, the transport ID that identifies the data stream over which the targeted advertisement will be broadcast, profile characteristics associated with the targeted advertisement, and a duration of the targeted advertisement. One exemplary multicast message format may be:

```
<begin profile>
  StartTime=17:32:30
  Duration=00:30
  ID=GroceryStoreAd001
  Alt=GC001Alt01
  C2248,V9928
  VPID=1190
  Alt=GC001Alt02
  C9801
  VPID=1192
  Alt=GC001Alt003
  V432
  VPID=1194
  <end profile>
```

When client device 114 detects multicast message 610, profile filter 518 compares the profile characteristics associated with the targeted advertisement to profile characteristics associated with the subscriber (as stored in subscriber profile data repository 520). If the profile characteristics don't match, then client device 114 remains tuned to data stream 604, which includes a default advertisement that was inserted by ad insertion system 134. However, if the profile characteristics of the targeted advertisement do match profile characteristics associated with the subscriber, then after the cue signal is detected, client device 114 listens for a trigger signal (e.g., a splice point). When the trigger signal is detected, client device 114 tunes to the data stream 616, which includes the targeted advertisement. After the duration specified in the multicast message, upon detection of another trigger point, client device 114 tunes back to data stream 604.

Advertisement Targeting Method

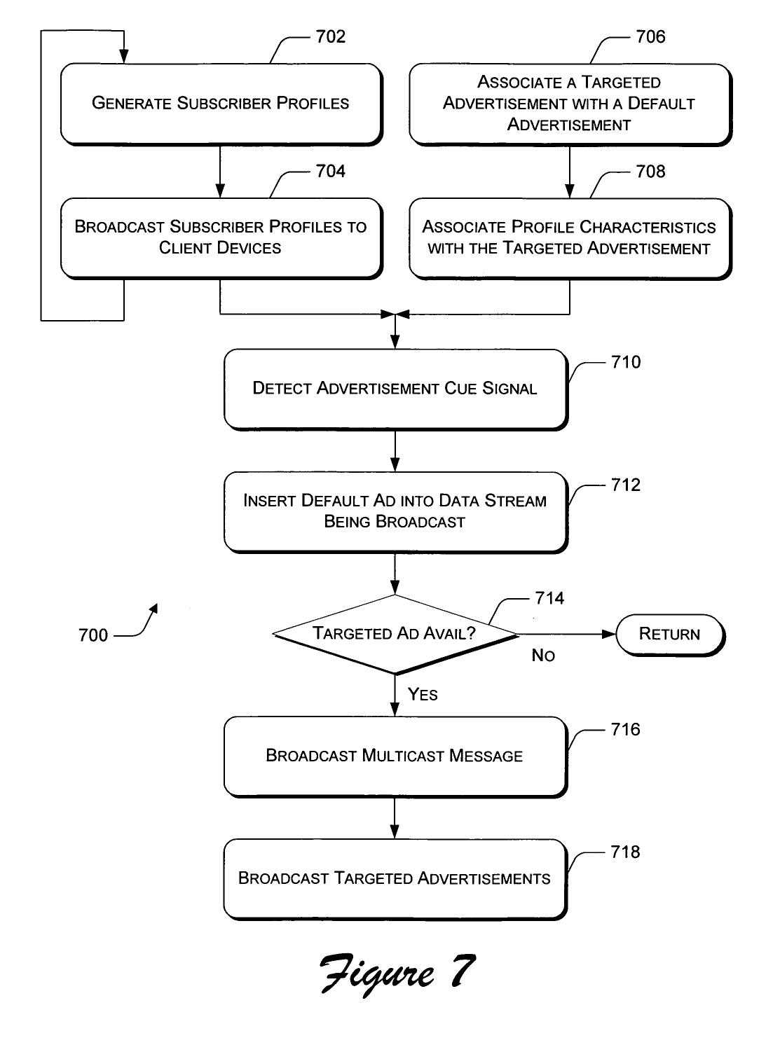

FIG. 7 is a flow diagram that illustrates an exemplary method 700 for targeting advertisements based on consumer purchasing data. The illustrated process can be implemented in any suitable hardware, software, firmware or combination thereof.

At block 702, the system generates subscriber profiles. For example, profile generator 120 processes data from television billing system data repository 104 and customer loyalty data repository 102, generating subscriber profiles that are stored in subscriber profile data repository 122.

At block 704, the system broadcasts the generated subscriber profiles to client devices 114. For example, profiling server 104 transmits data stored in subscriber profile data repository 122 to headend 110, which then broadcasts the subscriber profile data, for example, over an out-of-band network, to client devices 114. In an exemplary implementation, subscriber profiles are re-generated and re-broadcast on a regular schedule (e.g., once a month) as additional consumer purchasing data is gathered. Subscriber profile data may also be broadcast repeatedly to ensure that each client device has the opportunity to download the profile data (e.g., one or more client devices may be powered off when the profile data is initially downloaded).

At block 706, the system associates one or more targeted advertisements with a default advertisement. For example, an advertising company representative may access targeting server 108 through targeting user interface 124. A company may desire to target several different products to different television viewers based on whether or not specific viewers have shown an interest in particular products, based on their previous product purchases. For example, a company like Proctor and Gamble sells, among other things, toothpaste, coffee, and diapers. A company representative responsible for advertising may, through targeting user interface 124, identify a toothpaste advertisement as a default advertisement. A coffee advertisement and a diaper advertisement may be identified as targeted advertisements. In this way, the coffee and diaper ads can be targeted, but to viewers for whom coffee and/or diapers are not of interest, the default toothpaste ad may be shown.

At block 708, profile characteristics are associated with the targeted advertisement. For example, through targeting user interface 124, an advertising representative may specify that coffee purchasers are to be associated with the coffee advertisement and that diaper purchasers are to be associated with the diaper advertisement. Furthermore, targeting user interface 124 may be configured to allow a priority to be assigned to each targeted advertisement. For example, if a particular viewer has previously purchased both coffee and diapers, it may be most desirable to show the viewer the diaper advertisement. Accordingly, the diaper advertisement can be assigned a higher priority than the coffee advertisement.

As illustrated in FIG. 7, the processing described with reference to blocks 706 and 708 can be performed before, during, or after the processing described with reference to blocks 702 and 704.

At block 710, headend 110 detects a cue signal indicating an upcoming local ad avail.

At block 712, headend 110 inserts a default advertisement associated with the upcoming local avail into the data stream that is currently being broadcast. For example, ad insertion system 134 inserts a pre-determined default advertisement into the data stream that contains the cue signal.

At block 714, the system determines whether or not the upcoming ad avail is to include targeted advertisements. For example, headend 110 notifies targeting server 108 of the upcoming local ad avail ID. Targeting server 108 looks up data in targeted ad data store 126 to determine whether or not targeted ads are to be broadcast in association with the upcoming ad avail. If not (the “No” branch from block 714), then processing for the upcoming ad avail is complete.

However, if it is determined that the upcoming ad avail is to include targeted advertisements (the “Yes” branch from block 714), then at block 716, headend 110 broadcasts a multicast message over an out-of-band channel of network 112. The multicast message serves as notification to client devices 114 that a targeted ad spot is coming up. In an exemplary implementation, the multicast message includes data that indicates the duration of the upcoming ad spot, transport IDs identifying data streams over which each targeted advertisement is scheduled to be broadcast, and profile characteristics associated with each of the alternate advertisements.

At block 714, headend 110 simultaneously broadcasts the one or more targeted advertisements over the alternate data streams.

Method for Rendering Targeted Advertisements

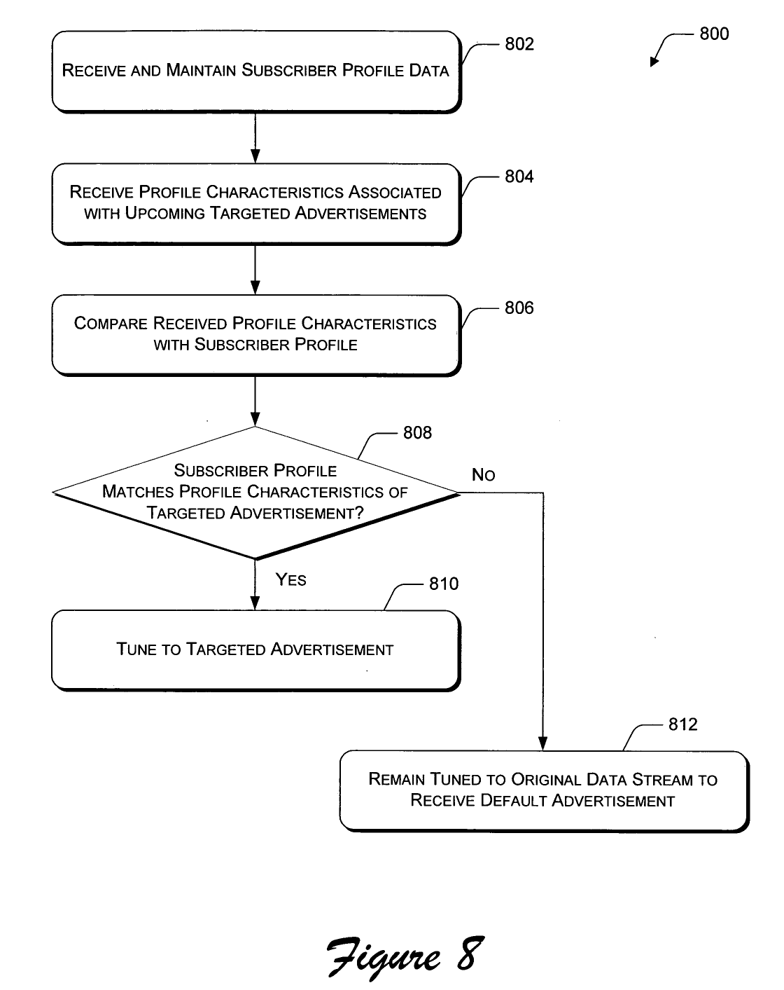

FIG. 8 is a flow diagram that illustrates an exemplary method 800 for receiving targeted advertisements. The illustrated process can be implemented in any suitable hardware, software, firmware or combination thereof.

At block 802, client device 114 receives and maintains subscriber profile data. As described above this process may occur repeatedly over time as subscriber profiles are updated with more current consumer purchasing data. In an exemplary implementation, subscriber profile data is broadcast over an out-of-band network channel with each set of profile data associated with a client device ID. Client device 114 listens to the data being transmitted over the out-of-band channel, and when the client device 114 detects its client device ID, it acquires the associated subscriber profile data and stores it in subscriber profile data repository 420.

At block 804, client device 114 receives a multicast message indicating profile characteristics, transport IDs, and a duration associated with an upcoming targeted advertisement avail. In the described implementation, client device 114 monitors data transmitted over an out-of-band channel and detects a multicast message that contains data associated with an in-band broadcast channel that the client device is currently tuned to.

At block 806, client device 114 compares the received profile characteristics with the previously stored subscriber profile characteristics.

At block 808, client device determines whether or not the received profile characteristics match the previously stored subscriber profile characteristics. For example, profile filter 418 extracts the profile characteristics specified in the multicast message and compares them to data stored in subscriber profile data repository 420.

If the profile characteristics match (the “Yes” branch from block 808), then at block 810, client device 114 tunes to the alternate data stream identified by a transport ID associated with the targeted advertisement. For example, profile filter 418, at six seconds following the cue signal associated with the local ad avail, directs in-band tuner 402 to tune to an alternate data stream based on the specified transport ID.

However, if the profile characteristics don't mach (the “No” branch from block 808), then at block 812, client device 114 remains tuned to the original data stream over which the default non-targeted advertisement will be broadcast.

Conclusion

The systems and methods described above enable targeted advertising based on consumer purchasing data.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
processing consumer data that represents an individual's consumer purchases; and
targeting a television advertisement to the individual based on the consumer data.

2. The method as recited in claim 1 wherein the individual comprises a subscriber to a broadcast television system.

3. The method as recited in claim 1 wherein the consumer data comprises data collected by a retail store in association with a membership card that is assigned to the individual.

4. The method as recited in claim 1 wherein the consumer data comprises an indicator of a vendor associated with a product that the individual has purchased.

5. The method as recited in claim 1 wherein the consumer data comprises an indicator of a category associated with a product that the individual has purchased.

6. The method as recited in claim 1 wherein the processing comprises:
accessing the consumer data associated with the individual; and
generating a profile associated with the individual based on the consumer data, such that the profile indicates a product category associated with a product purchased by the individual.

7. The method as recited in claim 6 wherein the product category is selected from a group of product categories comprising frozen foods, soft drinks, snack foods, cereals, diet foods, personal hygiene, and dental hygiene.

8. The method as recited in claim 6 wherein the profile further indicates a product vendor associated with the product purchased by the individual.

9. The method as recited in claim 1 wherein the targeting comprises:
associating a consumer profile characteristic with an advertisement to be targeted;
broadcasting data identifying the consumer profile characteristic associated with the advertisement to be targeted to enable a client device to determine whether or not to tune to the targeted advertisement; and
broadcasting in a first data stream a default, non-targeted advertisement, while simultaneously broadcasting in a second data stream the advertisement to be targeted.

10. The method as recited in claim 9 wherein the consumer profile characteristic comprises at least one of a product vendor and a product category.

11. One or more computer-readable media having computer-readable instructions thereon which, when executed by a computer, cause the computer to implement the method as recited in claim 1.

12. A system comprising:
a profiling server configured to generate consumer profiles associated with broadcast television system subscribers;
a targeting server configured to maintain consumer profile characteristics in association with targeted advertisements; and
a broadcast transmitter configured to broadcast consumer profile data and targeted advertisements over a network to multiple client devices.

13. The system as recited in claim 12 wherein the profiling server comprises:
a profiling user interface configured to enable a user to enter rules that define how the profiling server communicates with a customer loyalty data repository from which consumer purchase data can be extracted.

14. The system as recited in claim 13 wherein the profiling user interface is further configured to enable a user to indicate specific values that may be used in defining a subscriber profile.

15. The system as recited in claim 14 wherein the specific values comprise at least one of a product vendor and a product category.

16. The system as recited in claim 12 wherein the profiling server comprises:
a subscriber profile data repository configured to maintain consumer profile data associated with subscribers to a broadcast television system.

17. The system as recited in claim 12 wherein the targeting server comprises:
a targeting user interface configured to enable a user to specify consumer profile characteristics to be associated with targeted advertisements.

18. The system as recited in claim 12 wherein the targeting server comprises:
a multicast message generator configured to generate a message comprising:
a transport ID that identifies a data stream over which a particular targeted advertisement is scheduled to be broadcast;
a duration of the particular targeted advertisement; and
a consumer profile characteristic associated with the particular targeted advertisement.

19. The system as recited in claim 18 wherein the broadcast transmitter is further configured to broadcast the message that is generated by the multicast message generator.

20. A system comprising:
a first tuner configured to tune to a first network channel over which broadcast television program content may be received;
a second tuner configured to tune to a second network channel over which broadcasted television subscriber profile data may be received; and
a profile filter configured to direct the first tuner to tune to an alternate network channel over which a targeted advertisement may be received when a consumer profile characteristic associated with the targeted advertisement matches the television subscriber profile data.

21. The system as recited in claim 20 wherein the first network channel comprises an in-band network channel.

22. The system as recited in claim 20 wherein the second network channel comprises an out-of-band network channel.

23. The system as recited in claim 20 further comprising:
a subscriber profile data repository configured to maintain consumer profile data associated with a particular client device ID.

24. One or more computer-readable media comprising computer-readable instructions which, when executed, cause a computer system to:
associate a consumer profile characteristic with a targeted advertisement;
upon detection of an advertisement avail that is to include a targeted advertisement, generate a message that identifies the consumer profile characteristic that is associated with the targeted advertisement, a duration of the targeted advertisement, and a transport ID that identifies a data stream over which the targeted advertisement is scheduled to be broadcast; and
broadcast the message over a network to one or more client devices.

25. The one or more computer-readable media as recited in claim 24 further comprising computer-readable instructions which, when executed, cause a computer system to:
simultaneously broadcast a default advertisement on a first data stream and the targeted advertisement on a second data stream.

26. One or more computer-readable media comprising computer-readable instructions which, when executed, cause a computer system to:
receive consumer profile data associated with a broadcast television system subscriber;
receive a message comprising a consumer profile characteristic associated with a targeted advertisement scheduled for broadcast;
determine whether the consumer profile data associated with the broadcast television system subscriber matches the consumer profile characteristic associated with the targeted advertisement; and
in an event that the consumer profile data matches the consumer profile characteristic, tune from a first data stream to an alternate data stream over which the targeted advertisement is to be broadcast.

27. The one or more computer-readable media as recited in claim 26 wherein the message further comprises a transport ID that identifiers the alternate data stream.

28. The one or more computer-readable media as recited in claim 26 wherein the message further comprises a duration associated with the targeted advertisement, further comprising computer-readable instructions which, when executed, cause a computer system to:
after being tuned to the alternate data stream for a time period indicated by the duration, tuning back to the first data stream.
